(19) United States
(12) Patent Application Publication
(10) Pub. No.: US 2005/0099964 A1
(43) Pub. Date: May 12, 2005

(54) Methods and systems for automatically populating network route table

(75) Inventors: Robert J. Delaney, Raleigh, NC (US); Todd Eichler, Wake Forest, NC (US); Peter J. Marsico, Chapel Hill, NC (US)

Correspondence Address: JENKINS & WILSON, PA, 3100 TOWER BLVD, SUITE 1400, DURHAM, NC, 27707, US

(73) Assignee: Tekelec

(21) Appl. No.: 10/985,824

(22) Filed: Nov. 10, 2004

Related U.S. Application Data
(60) Provisional application No. 60/518,710, filed on Nov. 10, 2003.

(51) Int. Cl. H04L 12/28

(52) U.S. Cl. 370/254; 370/395.31

(57) ABSTRACT

Methods and systems for automatically populating a network routing table are disclosed. According to one method, where one node includes a route table auto-population application and an adjacent node does not, SS7 network management procedures are used to automatically populate the route table of the requesting node. In another method in which adjacent nodes include route table auto-population applications, the requesting node establishes a secure connection with each adjacent node, requests copies of the route tables from each adjacent node, and uses the received information to populate its route tables. In another implementation, a route table auto-population application dynamically requests and receives routing information for a destination for which no route exists in its route table in response to a received signaling message to be routed to the destination.

### RELATED APPLICATIONS

This application claims the benefit of U.S. Provisional Patent Application Ser. No. 60/518,710, filed Nov. 10, 2003, the disclosure of which is incorporated herein by reference in its entirety.

### TECHNICAL FIELD

The subject matter described herein relates to methods and systems for populating route tables in a telecommunications network. More particularly, the subject matter described herein relates to methods and systems for automatically populating route tables in an SS7 network.

### BACKGROUND ART

In order to route SS7 messages, network elements within the SS7 network must be configured with the identity and path to each network element within that network. In SS7 networks, routing is performed by message transfer part (MTP) level 3 functions in a network routing element. MTP level 3 functions examine destination point codes in received messages, look up the destination point codes in a route table, and determine the outbound signaling link to which messages with the destination point code should be routed. Thus, a route table associates point codes in a network with signaling links or output ports in a network routing node.

During the commissioning of a network element, point codes and routing information must be entered into the network element. Due to large number of available destination point codes and their routes, the information represents a considerable amount of data that must be entered into a network element. This entry is either performed manually by a craftsperson at a terminal or via an automated provisioning system that enters the data one command at a time. Both manual and automated provisioning of route tables are time- and labor-intensive. Due to the time- and labor-intensive nature of route table construction in conventional SS7 network elements, there exists a long felt need for improved methods and systems for populating SS7 route tables.

### DISCLOSURE OF THE INVENTION

The subject matter described herein includes methods and systems for automatically populating a route table with status information for a plurality of destination addresses. In one implementation, a plurality of destination addresses is stored in a route table. A first linkset connected to an adjacent node is activated, and a list of prohibited destinations is requested. Once the list of prohibited destinations is received, for each destination address that is not in the list of prohibited routes, a message is sent to the adjacent node to determine the status of the route to each destination via the adjacent node. Once the status information is received, entries in the route table are updated to reflect the current route status to each destination address.

In the automatic route table population method described in the proceeding paragraph, the route status can be obtained from an adjacent node using SS7 network management procedures that are normally used for MTP restart and signaling route set test operations. For example, the list of unreachable destination addresses can be obtained using an MTP restart procedure. For each destination that is not in the prohibited or unreachable list, a route set test message can be sent to the adjacent node. The route status field in the route set test message is set to prohibited. In response to the route set test message, the adjacent node sends a transfer allowed message for each route for which the route status is allowed. The requesting node uses the status information in the transfer allowed messages to update the route statuses in its route table. For each DPC that is not provisioned in the adjacent node, the adjacent node may send a TFP to the requesting node.

In a closed network in which routing nodes each include automated route status update applications according to the present invention, updating the route status may include establishing a connection with an adjacent node, requesting route tables from the adjacent node, and storing the route tables received from the adjacent node. These steps can be repeated for each adjacent node to obtain route tables from each adjacent node. The route tables from all of the adjacent nodes can then be combined and stored as a route table.

In yet another alternate implementation, route tables can be populated on the fly using real-time route set test messages to determine the outbound route when a message is received. According to this implementation, when a node receives a message destined for a destination point code that is not present in the route table, the message is buffered. A route set test message is then sent to all adjacent nodes serviced by B or D links. If a TFA is received from a destination with an available outbound route, the route table is updated and used to route the message. Thus, routes can be updated on the fly even if entries are not present in a nodes route table.

Accordingly, it is an object of the subject matter described herein to provide methods and systems for automatically populating a route table.

It is another object of the subject matter described herein to provide methods and systems for automatically populating a route table using network management procedures normally used for MTP restart and testing of prohibited routes.

Some of the objects of the subject matter described herein having been stated hereinabove, and which are addressed in whole or in part by the subject matter described herein, other objects will become evident as the description proceeds when taken in connection with the accompanying drawings as best described hereinbelow.

### BRIEF DESCRIPTION OF THE DRAWINGS

Preferred embodiments of the subject matter described herein will now be explained with reference to the accompanying drawings of which:

FIG. 1 is a network diagram illustrating the addition of a new STP to a network;

FIG. 2 is a network diagram illustrating deployment of a new STP capable of populating its own route table according to an embodiment of the subject matter described herein;

FIGS. 3A and 3B are a flow chart illustrating exemplary steps that may be performed between an STP with route table auto-population functionality and multiple adjacent STPs without route table auto-population functionality according to an embodiment of the subject matter described herein;

FIG. 4 is a flow chart illustrating exemplary steps that me be performed by an STP with route table auto-population functionality in obtaining route tables from other STPs that also have route table auto-population functionality using a secure IP connection according to an embodiment of the subject matter described herein;

FIG. 5 is a flow chart illustrating exemplary steps that may be performed by an STP with route table auto-population functionality in obtaining route tables from other STPs that also have route table auto-population functionality using a secure SS7 connection according to an embodiment of the subject matter described herein;

FIG. 6 is a flow chart illustrating exemplary steps that may be performed by an STP with route table auto-population functionality in obtaining an initial route table and dynamically obtaining unknown routes according to an embodiment of the subject matter described herein; and

FIG. 7 is a block diagram illustrating an exemplary STP with automatic route table population capabilities according to an embodiment of the subject matter described herein.

### DETAILED DESCRIPTION

In one implementation of the subject matter described herein, a network operator may populate a destination point code table with point codes of all nodes to which the node is expected to route and connect links and linksets to the adjacent point codes serviced by A, B, C, and D links. One at a time, the non-A links and linksets are brought into service to the adjacent nodes, and the network element will interrogate its adjacent network element for the route status of each provisioned destination point code. The routing information may be returned via the MTP Restart Procedure, for example, as described in GR-246-Core T1.111.4 Section 9.4, the disclosure of which is incorporated herein by reference in its entirety and then be the route set test procedure, for example, as described in GR-246-Core T1.111.4 Section 13.5, the disclosure of which is incorporated herein by reference in its entirety. This information may be used to confirm that the destination in question can be reached via the adjacent node and provide the current route status of the destination in question. This information may be used to self populate the route table.

In addition to performing route table auto-population between one node that is capable of auto-population and another node that is not, the subject matter described herein allows network operators deploy networks elements that share the subject matter described herein. The subject matter described herein allows the operators to establish sharing relationships between deployed nodes. The sharing relationship allows the network element to completely divulge its destination and route table to a requesting network element. This aspect of the subject matter described herein only requires that the operator bring an SS7 or IP link to the partner network element into service. The requester then interrogates the partner, and, after confirmation of the requestor's identity, the partner relays all pertinent data.

In addition to automatically populating route tables at node setup time, the subject matter described herein also allows the operator to populate the network elements route table via real-time route set test messages to determine the outbound route. An incoming message bound for a destination point code that is not present in the routing table may be buffered and a route-set-test message is sent to all adjacent nodes serviced by B, C, or D links. The first outbound route that responds with a confirmation of an available route for the received destination point code would be chosen as the outbound route for the buffered MSU. The destination/route combination would then be added to the route table.

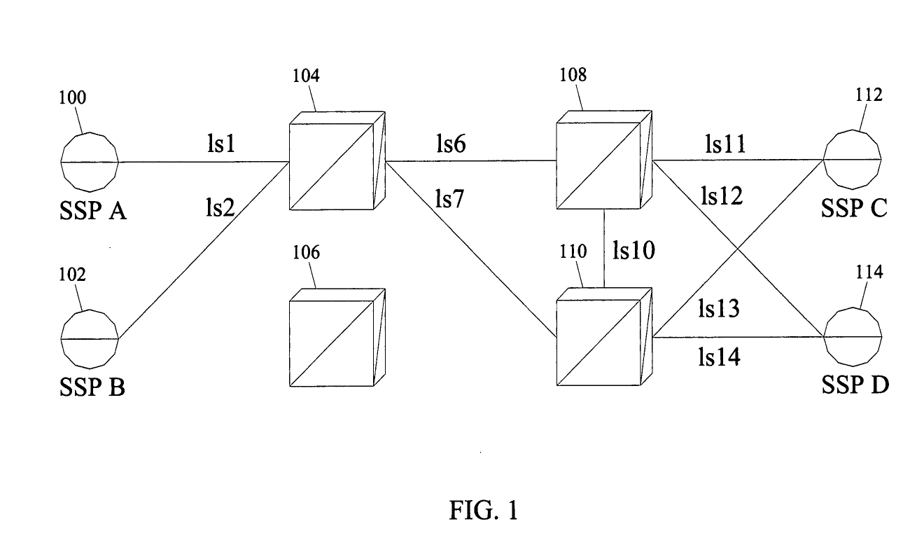

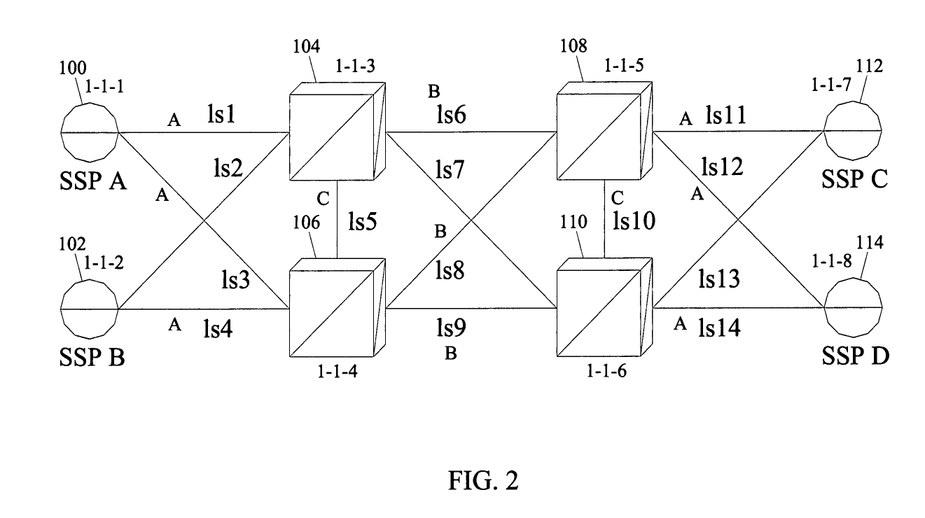

FIG. 1 is a network diagram illustrating an exemplary signaling network in which the methods and systems described herein may be implemented. In FIG. 1, a network operator owning the SSP pair SSP A 100, SSP B 102, and STP 104, desires to deploy a second STP 106 as the mate to STP 104. STPs 108 and 110 and SSPs 112 and 114 are also connected to the network illustrated in FIG. 1. Thus, any STP added to the network illustrated in FIG. 1 is preferably provisioned with all of the point codes of the nodes illustrated in FIG. 1. When STP 106 is deployed as shown in FIG. 2, the operator will have to enter all of the destination point codes that STP 106 is expected to route to and construct routes to all of those point codes as well. STPs 104, 108, and 110 already contain much of this information, but it is not easy to replicate the data from these other network elements due to the uniqueness of an individual network element and the stand-alone nature of the network elements involved. The subject matter described herein provides a way to quickly and efficiently create a working destination route table on a newly installed network element.

For the embodiments described below the following rules may apply:
1) If an adjacent node does not respond to a route-set-test (RST) message, the route statuses agree, and no message is returned. Alternatively, a network failure has prevented the response from being sent.
2) If a point code is not provisioned at the signal transfer point, a transfer-prohibited message is returned in response to a route-set-test message regardless of the status in the RST message.
3) If a transfer prohibited (TFP) message is returned in response to a route-set-test message that has the route status set to “prohibited,” the destination and route tables are left blank.
4) If a transfer restricted (TFR) message is returned in response to an RST message, the destination and route tables are updated with the affected point code and a route is added to the route table of the node that sent the RST message. In addition the route status is marked as restricted for that route.
5) Normal SS7 network management message handling procedures will deal with any MSU bound for a restricted or prohibited node. The subject matter described herein preferably only seeks to populate the tables and does not affect normal routing rules.
6) A like element, as used herein, is a network element that shares route table auto-population capabilities with a requesting element.
7) An unlike element, as used herein, is a network element that does not share route table auto-population capabilities with a requesting node.

### Embodiment 1: Self Population Between Unlike Network Elements

In one implementation, the subject matter described herein requires that the network operator populate a destination point code table and construct links and linksets to the adjacent point codes serviced by A, B, C, and D links. As used herein, the terms “destination point code table” and “destination table” refer to a table that contains a list of all routable destination point codes in a network. Using the network illustrated in FIG. 2 as an example, a destination point code table maintained by STP 106 may include 1-1-1 through 1-1-3 and 1-1-5 through 1-1-7. A route table includes the DPC values, the corresponding linksets, and the corresponding route statuses. Table 1 shown below is a simplified example of a route table that may be maintained by STP 106.

TABLE 1
Route Table for Network Illustrated in FIG. 2

| DPC | Linkset | Status | Cost |
|---|---|---|---|
| 1-1-1 | LS3 | up | 10 |
| | LS5 | up | 30 |
| 1-1-2 | LS4 | up | 10 |
| | LS5 | up | 30 |
| 1-1-3 | LS5 | up | 30 |
| 1-1-5 | LS8 | up | 20 |
| | LS5 | up | 30 |
| | LS9 | up | 20 |
| 1-1-6 | LS9 | up | 20 |
| | LS8 | up | 20 |
| | LS5 | up | 30 |
| 1-1-7 | LS8 | up | 20 |
| | LS5 | up | 30 |
| | LS9 | up | 20 |
| 1-1-8 | LS5 | up | 30 |
| | LS8 | up | 20 |
| | LS9 | up | 20 |

In Table 1, A links are assumed to have a cost of 10, B links are assumed to have a cost of 20, and C links are assumed to have a cost of 30. These costs may be assigned automatically by the route table auto-population application based on the linkset type.

One at a time the non-A linksets are brought into service to the adjacent nodes by the subject matter described herein. The network element will interrogate its adjacent network element for the route status of each provisioned destination point code. As described above, the routing information may be returned via the MTP Restart Procedure, GR-246-Core T1.111.4 Section 9.4, and then route set test message procedures, GR-246-Core T1.111.4 Section 13.5. This information will be used to confirm that the destination in question can be reached via the adjacent node and will provide the current route status of the destination in question. This information will be used to self populate the route table.

Self-population of route tables between unlike network elements will now be described. The information used for self-population may be gleaned from interrogating an adjacent network element that is served by a B, C, or D link and does not host a route table auto-population application.

If the operator is deploying a new STP, such as STP 106 shown in FIG. 2 a certain amount of provisioning is required. The following items must be configured for any A, B, C, or D links.
Site ID, unique to the individual STP.
Adjacent point codes.
Linksets to adjacent point codes.
Links to adjacent point codes.
Routes to adjacent point codes.

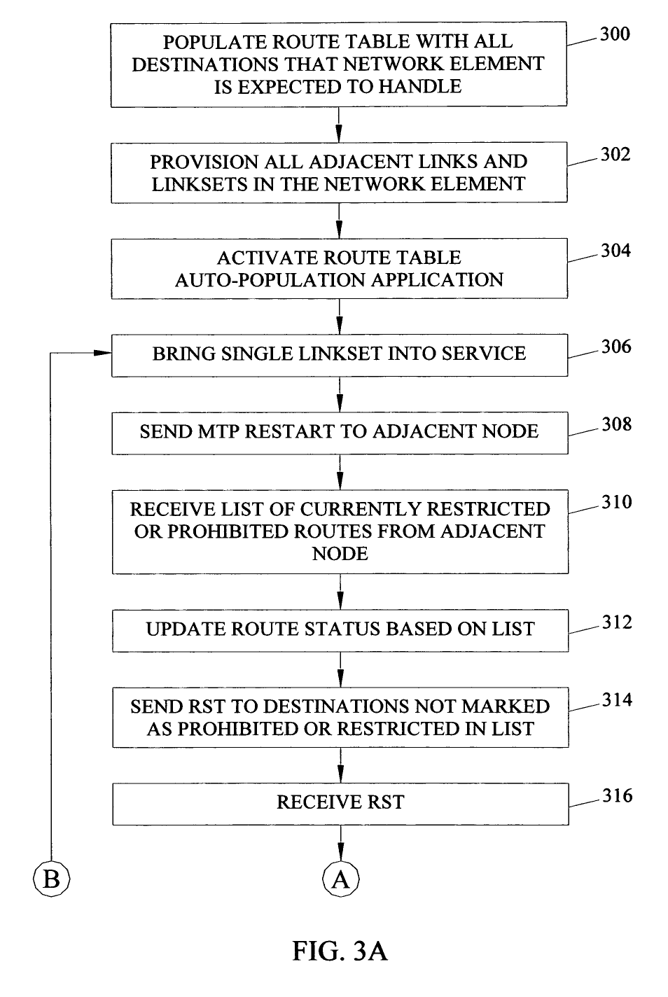

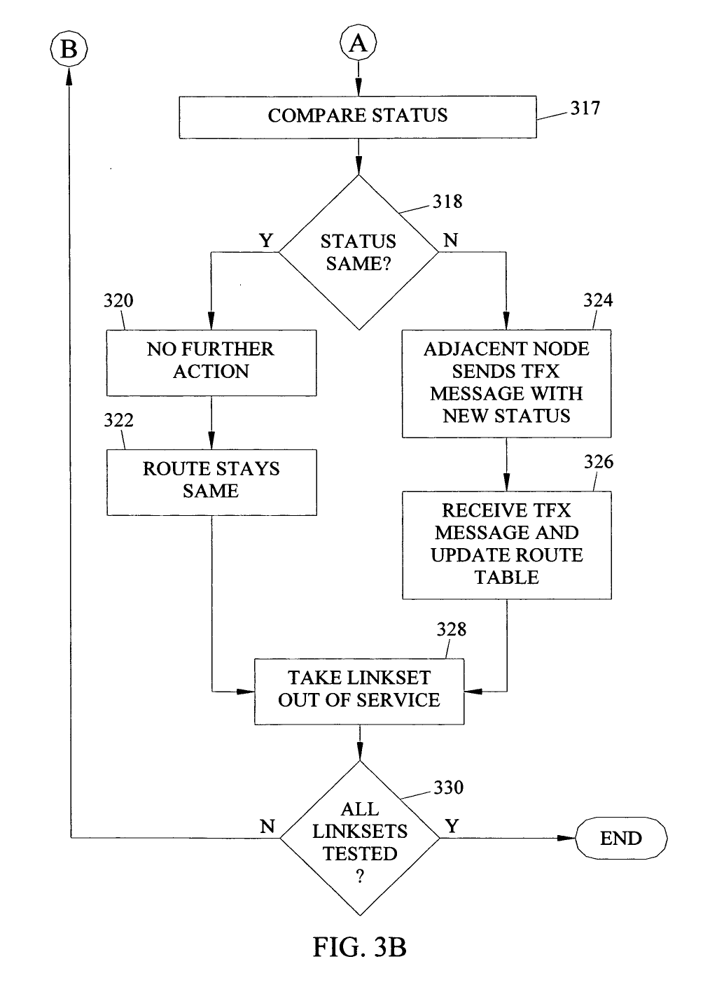

FIGS. 3A and 3B are a flow chart illustrating exemplary steps for automatically populating a network route table between unlike destinations according to an embodiment of the subject matter described herein. Referring to FIG. 3A, in step 300, the operator may begin by populating the route table with all of the destination point codes that this network element is expected to handle. In step 302, the operator then provisions all of the adjacent links and linksets for the network element. In step 304, a route table auto-population application is activated, and in step 306, a single linkset from the available list of B, C, or D linksets is brought into service. Note that no user traffic would be allowed at this point as no A linksets are presently activated in the system. The route table auto-population application may use the following hierarchy to determine which is first to be interrogated.
1) C links
2) B Links
3) D Links

In step 308, the route table auto-population application begins by sending an MTP Restart message, TRW, to the adjacent node. The purpose of this message is to force the adjacent node to send all of the currently restricted or prohibited routes to the restarting node. This follows current GR-246-Core T1.111.4 Section 9.4 expectations for receiving an unexpected TRW. In step 310, the route table auto-population application receives the list of currently restricted or prohibited routes from the adjacent node. In step 312, the route table auto-population application updates the route table with these routes and flags the current route status per the adjacent node being interrogated. The route table auto-population application then assumes that all other destinations in the route table are allowed, or not provisioned, in the adjacent node. Note that in an ITU environment the TRW message does not exist. For eliciting the current route status of all TFP and TFR routes from the adjacent network element this is unimportant and can be achieved in another way using ITU MTP Restart. By comparing the returned TFR/TFP messages to its own SID the route table auto-population application is likely to receive a TFR concerning its own point code. This information may be discarded.

In step 314, the route table auto-population application reads the provisioned route table and sends a route-set-test message to the adjacent network element concerning each entry that is not in the list of prohibited or restricted in the list. The current route status and the fact that the adjacent node can route to those point codes are known facts.

Per GR-246-Core T1.111.4 Section 13.5:

The signaling route-set-test procedure is used at the signaling point to test whether or not signal traffic towards a certain destination may be routed via an adjacent signaling transfer point. The procedure makes use of the signaling route-set-test message, the transfer-allowed, the transfer-prohibited, and the transfer-restricted procedures.

The signaling route-set-test message contains:
1) The label, indicating the destination and originating points,
2) The signaling route set test signal,
3) The destination or, optionally, cluster of destination, the accessibility of which is to be tested, and
4) The current route status of the destination being tested.

The route-set-test message may be populated as follows:
1) The label would have the OPC=network element being populated and the DPC=to the adjacent node's point code.
2) The signaling route set test signal H0 H1 codes are set as appropriate.
3) The destination would be entered as the destination under test pulled from the destination point code table.
4) The current route status is handled thusly, since the MTP restart procedure detailed in Step 1 only returns destinations that are currently prohibited or restricted, all of the route-set-test messages will have their current route status fields marked as prohibited.

Referring to FIG. 3B, in step 316, the adjacent node receives the RST message. In steps 317 and 318, the adjacent node compares the status of the destination in the received message with the actual status of the destination. If they are the same, no further action is taken (step 320). Routes for which no response message is received remain the same (step 322). If they are different, one of the following messages is sent in response (step 324), dictated by the actual status of the destination:
1) A transfer-allowed message, referring to the destination the accessibility of which is tested, if the signaling transfer point can reach the indicated destination via a signaling link not connected to the signaling point from which the signaling route-set-test message was originated via normal routing.
2) A transfer-restricted message where access to the destination is possible via the normal route, which is in danger of congestion or via an alternate to the normal routing which is less efficient. In addition, the originator of the route-set-test message is not a signaling transfer point to which a transfer-prohibited message was sent when traffic was diverted to the current route.
3) A transfer-prohibited message is sent for any remaining cases, (including inaccessibility of that destination).

Since the destinations that are currently listed as prohibited and restricted were learned in step 310, setting all of the route-set-test messages to have a current route status of prohibited will yield all those point codes that are accessible via the interrogated node and have a route status of allowed. The interrogated node should send back a TFA for each DPC tested. A TFP will be sent if the point code in question is not provisioned at the adjacent node. Receiving a TFP at this point causes the point code in question to be skipped and no route will be entered for the adjacent node under test. Routes to these point codes may be filled in at a later time when the linkset through which the DPC is reachable is tested.

In step 326, the sending node receives the TFX (where X indicates allowed (A), restricted (R), or prohibited (P)) messages from the adjacent node and updates the route table. As the transfer-allowed messages are returned for each route-set-test message, the route table is updated with the following information:
destination point codes under test,
the linkset on which the RST/TFA messages are sent,
the adjacent point code,
the status of the route, allowed, and
the route cost, which may be adjustable per the user. Default route costs may be set at 10 for A links, 20 for B links, 30 for C links, 40 for D links, etc.

In step 328, the route table auto-population application now takes that linkset out of service and brings the next linkset into service. In step 330, the route table auto-population application determines whether all adjacent B, C, and D linksets have been tested. If all linksets have been tested, the route table auto-population application ends. If all linksets have not been tested, control returns to step 306 where the next linkset is brought into service and the route table auto-population application repeats steps 308-330 to generate route table entries for the next adjacent network element. In the case of destinations that are accessible by different adjacent network elements, multiple routes with route costs based on linkset type would be created and assigned to the destination point codes. Entries that were left blank in the first pass due to the destination point codes not being provisioned at the previous tested node are tested along with all the other destinations and will eventually be filled in the appropriate routes.

Once all the links have been tested, all of links can bring into service, and the system should be able to carry user traffic.

To better illustrate route table self-population between like network elements, an example of the route table after performing the steps illustrated in FIG. 3 for one of the linksets connected to STP 106 in FIG. 2 will now be provided. Referring to FIG. 2, in this example, it is assumed that STP 106 first brings linkset LS5 into service. It is also assumed that the routes to SSPs 100 and 102 via directly connected linksets are manually provisioned in STP 106. Table 2 shown below illustrates an example of the route table status prior to initiating the MTP restart procedure.

TABLE 2
Route Table of STP 106 in FIG. 2 Prior
to Route Table Auto-population

| DPC | Linkset | Route Status | Route Cost |
|---|---|---|---|
| 1-1-1 | LS3 | up | 10 |
| 1-1-2 | LS4 | up | 10 |
| 1-1-3 | — | — | — |
| 1-1-5 | — | — | — |
| 1-1-6 | — | — | — |
| 1-1-7 | — | — | — |
| 1-1-8 | — | — | — |

Table 3 shown below illustrates the route table that may be stored in STP 106 after the MTP restart procedure.

TABLE 3
Route Table of STP 106 After MTP Restart Procedure

| DPC | Linkset | Route Status | Route Cost |
|---|---|---|---|
| 1-1-1 | LS3 | up | 10 |
| 1-1-2 | LS4 | up | 10 |
| 1-1-3 | — | — | — |
| 1-1-5 | — | — | — |
| 1-1-6 | — | — | — |
| 1-1-7 | — | — | — |
| 1-1-8 | — | — | — |

In Table 3, it is assumed that STP 104 did not return any prohibited routes in response to the MTP restart. Accordingly, each destination in the table may be either not provisioned or available. For each of these destinations, STP 106 preferably sends an RST message to STP 104 to find the status of the associated route. Table 4 shown below illustrates the status of the route table after the RST procedure for linkset 5.

TABLE 4
Route Table of Table 6 After Implementing RST Procedure for LS5

| DPC | Linkset | Route Status | Route Cost |
|---|---|---|---|
| 1-1-1 | LS3 | up | 10 |
| 1-1-2 | LS4 | up | 10 |
| 1-1-3 | LS5 | up | 30 |
| 1-1-5 | LS5 | up | 30 |
| 1-1-6 | LS5 | up | 30 |
| 1-1-7 | LS5 | up | 30 |
| 1-1-8 | LS5 | up | 30 |

From Table 4, it can be seen that all of the destinations reachable via linkset 5 are now marked as up or allowed. Route costs have also been assigned to each route based on linkset type using the assumptions described above with respect to Table 1.

The procedure illustrated by Tables 2-4 is repeated for each B, C, and D linkset connected to STP 106. The final result is the route table of Table 1.

### Embodiment 2: Self Population Between Like Elements

The route table auto-population application allows network operators to deploy networks elements that share the route table auto-population application. The route table auto-population application allows the operators to setup sharing relationships between deployed nodes. The sharing relationship allows the network element to completely divulge its destination and route table to a requesting network element. The requestor then interrogates the partner and after confirmation of the requestor's identity, the partner relays all pertinent data.

This aspect of the subject matter described herein only requires that the operator bring a single link to the partner network element into service. The link can be created over an IP-based Ethernet network using a secure connection, such as secure shell. Once the link has been created and the client has been authorized using standard secure shell strong authentication means the actual destination and route tables can be transferred from the server network element using a secure transfer protocol, such as SFTP (secure file transfer protocol). The link can also be a standard SS7 link between the client and server and can be used to transfer traditional SS7 network messages that are used to populate the client's destination and route tables.

With either type of link, the client's operator in only required to provision a single connection to the server and the server is only required to be authorized to transfer its data to the client.

### Embodiment 2a: Secure IP Connection

With a secure shell connection a client is able to connection to a server using an encrypted IP connection that is protected against eavesdropping.

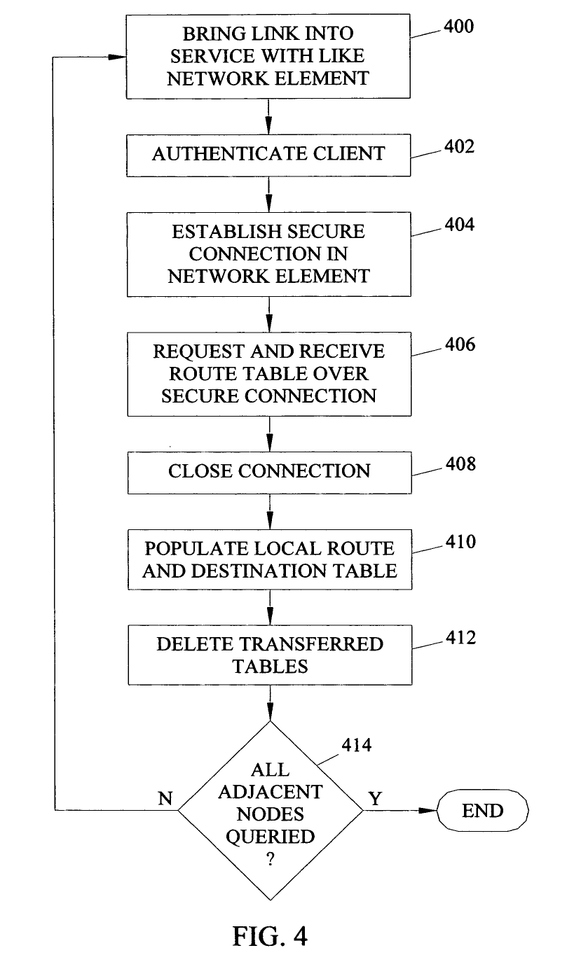

FIG. 4 illustrates exemplary steps that may be performed by a route table auto-population application in automatically populating its route table by communicating with a life network element over a secure IP connection according to an embodiment of the subject matter described herein. Referring to FIG. 4, in step 400, the route table auto-population application creates a secure connection from the new network element, referred to herein as the client, to the established network element, referred to herein as the server. In step 402, the client is authenticated by the server to confirm that the client is authorized to connect to the server and receive data. In step 404, the route table auto-population application establishes a secure connection with the server. The secure connection may be established using secure sockets layer (SSL) or other suitable secure connection establishment protocol.

In step 406, the route table auto-population application requests that the destination and route tables be transferred via a commonly-available transfer protocol, such as SFTP, and the server transfers the tables to the client. Currently, the provisioned tables for the destination point codes and the provisioned tables for the routes are sought. After the tables have been retrieved, the secure connection is closed (step 408).

In step 410, the route table auto-population application retrieves the destination and route tables from the server and examines the contents. The route table auto-population application searches for all point codes and routes to which the server has access. These destinations are added to the destination tables of the requesting node and a route for each of them will be created targeting the server as a possible route for any received MSUs. Any destination/route combination referring to the client network element is discarded.

In step 412, after the route table auto-population application has gleaned all the data from the server's destination and route tables, the transferred tables are deleted. In step 414, the route table auto-population application determines whether all B, C, and D linksets which correspond to adjacent nodes have been tested. If all linksets have been tested, the application ends. If all linksets have not been tested, control returns to step 400 where the next linkset is tested.

Although the destination and route tables are fully populated after the steps illustrated in FIG. 4 have been executed, it may be desirable to fine tune the route table, for example by removing redundant routes. Such editing may be performed manually by an operator. Alternatively, the route table auto-population application may detect and inform the operator of redundant routes and give the operator the opportunity to delete redundant entries. In yet another alternate implementation, redundant entries may be deleted automatically.

### Embodiment 2b: SS7 Connection

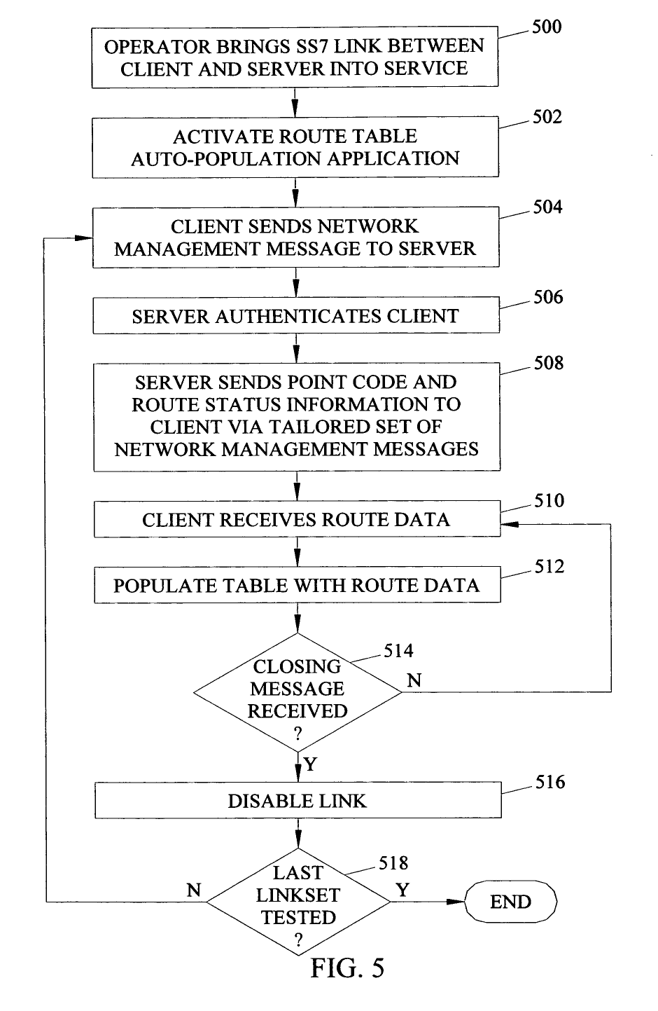

In yet another alternate implementation involving like network elements, the route table auto-population client may use a traditional SS7 connection to interrogate a server and gain the required data by exchanging SS7 network management messages. FIG. 5 is a flow chart illustrating exemplary steps that may be performed by a route table auto-population client in interrogating an auto-population server according to an embodiment of the subject matter described herein. Referring to FIG. 5, in step 500, an operator brings an SS7 link between the client and the server into service.

Once the link has been established between the client and server over a traditional SS7 link, in step 502 the operator activates the client's route table auto-population application. The route table auto-population application sends a network management message constructed to let the server's route table auto-population application know that a client is requesting data from the server. The network management message may be a new type of message, referred to herein as a route table data request message.

In step 506, the server authenticates the client. The server may either have a provisioned table of authorized client point codes or may require real-time authorization from a craftsperson. Once the authentication is complete, in step 508, the server's route table auto-population application begins to route a tailored set of SS7 network management messages to the client.

Receiving a special network management message authorizes the client's route table auto-population application. Failed authorizations may either not receive any messaging and may time out, or a failure network management message may be sent. Since the client is in explore mode, other normal SS7 messages may be ignored. The server may exchange point code and route status information by sending a stream of TFA, TFRs, and TFP messages. In step 510, the client receives the route data. In step 512, the client populates the route table with the route data. For example, the client may add each point code in the affected point code field to its destination table and add a route to that point code indicating the server as the adjacent point code. Route costs may be based on user input or default values, (links: “B”=20, “D”=30, and “C”=40). Any destination/route combination referring to the client network element may be discarded.

In step 514, the client determines whether a closing message has been received. If a closing message has not been received, control returns to step 510 where the client continues to receive route data. Once the closing message is received, the route table auto-population application on both sides inhibits and cancels the established link taking it to an OOS-MT-DSBLD state (step 516).

After the route table auto-population application has gleaned all the data from the server's messages, control proceeds to step 518 where it is determined whether all linksets have been tested. If all linksets have been tested, the process ends. If all linksets have not been tested, control returns to step 504 where the route table auto-population client, moves to the next linkset of the same type or to the next type on the list, (in order C, B, D) and repeats the process. When all of the adjacent links have been interrogated the auto provisioning is complete. The tables should be fully populated. Once the auto-provisioning is complete, the tables may be fine tuned, as described above.

### Embodiment 3: Ad Hoc Self Population

The route table auto-population application allows the operator to populate the network elements destination and route table via real time route-set-test messages to determine the out-bound route. First, the route table may be automatically provisioned as described above with regard to the first embodiment. A description of these steps will now be repeated. For example, at the onset of commissioning period, the operator initiates MTP restart TRW check on all B, C, and D, links.

The route table auto-population application begins by sending an MTP Restart message, TRW, to the adjacent node. The purpose of this step is to force the adjacent node to send all of the currently restricted or prohibited routes to the restarting node. This follows current GR-246-Core T1.111.4 Section 9.4 expectations for receiving an unexpected TRW. The route table auto-population application updates the route table with these routes and flags the current route status per the adjacent node being interrogated. The route table auto-population application then assumes that all other destinations in the destination table are allowed or not provisioned in the adjacent node. Note that in an ITU environment the TRW message does not exist. For eliciting the current route status of all TFP and TFR routes from the adjacent network element this is unimportant and can be achieved in another way using ITU MTP Restart. By comparing the returned TFR/TFP messages to its own SID the route table auto-population application is likely to receive a TFR concerning its own point code. This information would be discarded.

Since the route table auto-population application now has a list of restricted and prohibited routes for some of the point codes in the network. The route table auto-population application sends route-set-test messages with a “prohibited” route status to allowed adjacent, B, C, and D links. This will elicit any adjacent nodes that have allowed or restricted routes to send an updated route status to the invention. The route table auto-population application collects the returned network management messages and further updates the routing table with multiple routes.

For example in FIG. 2, if the point code of SSP 112 was marked as prohibited from STP 108 due to link failures. STP 108 would have sent a TFP in response to the unexpected TRW. The route table auto-population application on STP 106 may have entered STP 108 as a valid route to SSP 112 but would have marked the route as prohibited. In an effort to find another route, STP 106 may send RST messages about SSP C 112 with a route status as prohibited to all adjacent nodes that are serviced by B, C, and D links. Once the RST message is sent to STP 110, a TFA may be sent to STP 106 and the route table would be updated with the new route. Both routes now exist in the routing table and STP 106 is able to route the MSU via STP 110.

The destination/route learning mode for the subject matter described herein may be controlled by the operator. The route table auto-population application preferably does not add routes and destinations to the switch if the learning mode is turned off.

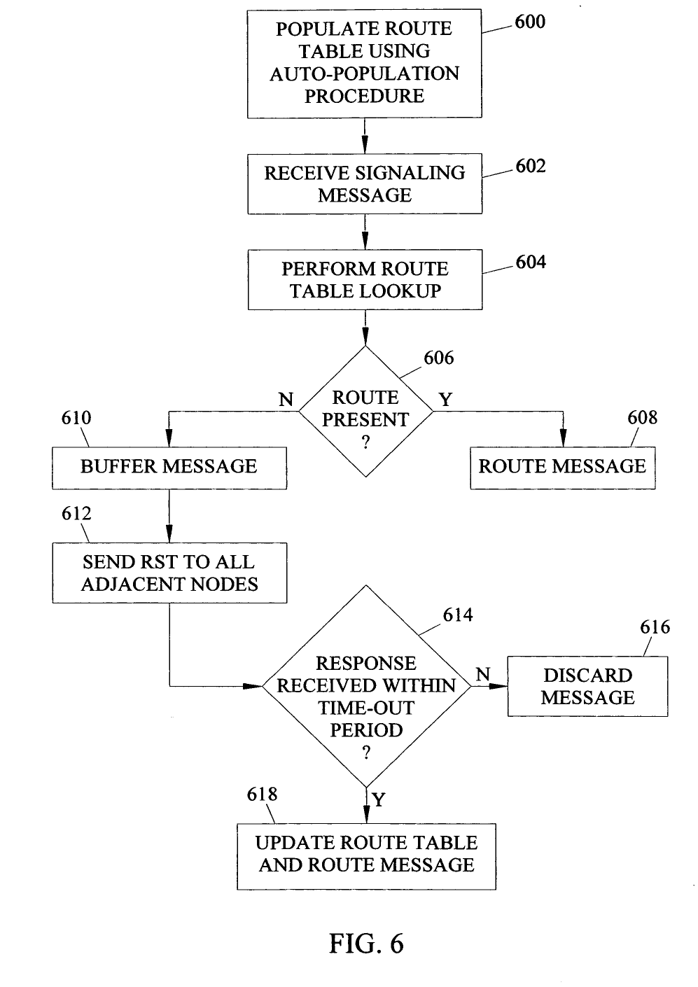

FIG. 6 illustrates an exemplary process for route table auto-population using real-time RST messages according to an embodiment of the subject matter described herein. Referring to FIG. 6, in step 600, the route table is populated using any of the auto-population procedures described herein. In step 602, a signaling message is received. In steps 604 and 606, an incoming message bound for a destination point code is checked against the route table. If the destination is present in the route table, no additional action is taken, even if the route table auto-population application is in learning mode. The message is then routed to its destination (step 608).

A message addressed to any destination that is not present in the routing table may be buffered (step 610). A route-set-test message would be sent to all adjacent nodes serviced by B or D links, (C links) (step 612). The route status of the route-set-test message may be set to “prohibited.” In step 614, it is determined whether a response to the RST message is received within the timeout period. If no responses are received, the message is discarded (step 616). If responses are received, control proceeds to step 18 where the route table is updated and the message is routed. In particular, the first outbound route that responds with a confirmation, TFA or TFR, of an available outbound route for the received destination point code may be chosen as the outbound route for the buffered MSU. In an alternate implementation, if multiple TFAs are received within the time period, the lowest cost route may be selected. The timer T10 (RST timer) runs in the order of 20-30 seconds. However, the operator can adjust the timer as needed on a point code basis (T1.114 page 13-5 Note 10).

The destination/route combination may then be added to the route table. Any additional responses may be added as multiple routes to the same destination and would be given route costs based on user provided information.

If a TFA/TFR is not received within a time out value governed by T10 the incoming MSU is discarded per GR-246, and the STP sends the appropriate network management message back to the originating node.

Since the adjacent node may only respond if the route status set in the RST message is different from the actual route status at the adjacent node, a no-response may indicate that the destination point code is provisioned at the adjacent node but the route is actually prohibited. Since the route status agrees with the RST message, no response is sent. A “no response” on a linkset may add the adjacent point code to the destination/routing table but may flag the route status as prohibited.

If the destination point code is not provisioned at the adjacent node, a TFP is sent in response to the RST message. If the requesting application receives a TFP no action is taken and the destination/route tables are not updated. The route table auto-population application still waits for a TFA/TFR.
No response=destination/route table updated with route to adjacent point code, route is marked prohibited, the MSU is not routed.
TFP=destination/route table is not updated. Adjacent node does not have DPC provisioned.
TFR=destination/route table is updated with the route to adjacent point code and the route is marked restricted, the MSU is routed.
TFA=destination/route table is updated with the route to adjacent point code and the route is marked allowed, the MSU is routed.

Once all the links time-out or respond, the MSU is either forwarded or discarded. If the tables were updated with a route, even one that was prohibited, the STP may either forward the MSU onto the adjacent node that responded with a TFA/TFR or respond to the originating node with a TFP. If no tables were updated due to receiving all TFPs, indicating that no adjacent node has the point code provisioned, the STP may discard the MSU per GR-246, (MTP received unknown DPC).

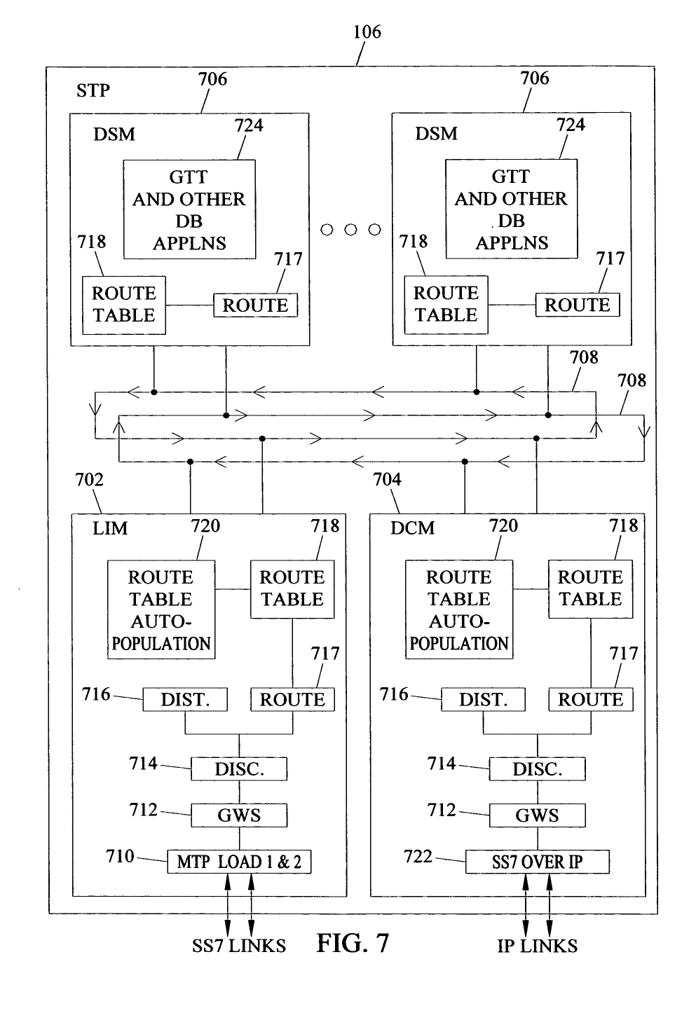

As indicated above, route table auto-population may be implemented in any suitable node, such as an STP. FIG. 7 is a block diagram illustrating an STP with a route table auto-population application according to the present invention. Referring to FIG. 7, STP 106 includes a link interface module 702, a data communications module 704, and database service modules 706. Modules 702, 704, and 706 each include a printed circuit board, an application processor for executing telecommunications applications, and a communications processor for communicating with other processing modules via counter rotating dual ring bus 708.

From a software perspective, LIM 702 includes MTP level 1 and 2 function 710 for performing MTP level 1 and 2 processing operations, such as error correction, error detection, and message sequencing. A gateway screening function 712 screens received messages to determine whether or not to allow the messages in the network. A discrimination function 714 determines whether a received message is to be processed by STP 700 or is to be routed over an outbound signaling link. This determination may be made base on the destination point code in a signaling message.

For messages that discrimination function 714 identifies as requiring internal processing, discrimination function passes the messages to distribution function 716. Distribution function 716 distributes the message to the appropriate internal processing module within STP 106. This distribution may be performed based on the message type as determined by message type identifiers in each signaling message. For example, SCCP messages may be distributed to one of plurality of DSMs 706 for global title translation or other processing operation.

For messages that discrimination function 714 identifies as requiring routing, discrimination function passes the messages to routing function 716. Routing function 716 access route table 718 to determine the outbound card and linkset over which a message is to be routed. Once the routing function 716 identifies the outbound card and linkset, the message is routed to the outbound or linkset via IMT bus 708.

According to the present invention, LIM 718 also includes a route table auto-population application 720 for automatically populating route table 718 using any of the methods described above. For example, in networks in which adjacent STPs do not have route table auto-population applications, route table auto-population application 720 may request routes using SS7 network management procedures that automatically update route table 718 using the information received via the network management messages. In networks in which adjacent STPs include route table auto-population applications, route table auto-population application 720 may simply request the route table from each adjacent node and store the requested information in route table 718.

DCM 704 includes SS7 over IP layers 722 for sending and receiving SS7 messages over IP signaling links. Layers 722 may include physical layer functions, network layer routing functions, transport layer functions, and adaptation layer functions for sending and receiving SS7 messages over IP signaling links. DCM 704 also includes function 712-720 that operate identically to the correspondingly numbered functions with regard to LIM 702. Accordingly, a description thereof will not be repeated herein.

DSMs 706 include GTT and other database applications 724, routing functions 717, and route tables 718. GTT and other database applications 724 perform routing address translations on received signaling messages, such as global title translations and number portability translations. After this translation is performed, routing functions 717 route the messages to the appropriate outbound signaling links based on the information in route tables 718. Because route tables 718 and STP 700 are preferably identical, once one route table auto-population application 720 populates route table 718, this information is preferably copied to route tables 718 on all of the other modules within STP 700. Alternatively, as illustrated in FIG. 7, each LIM and DCM may have its own route table auto-population application. In such an embodiment, each route table auto-population application may obtain the routes for the signaling linkset to which it its module is directly connected. The routing data collected for each linkset may then be shared among LIMs, DCMs, and DSMs, so that the route tables on each card will be identical. In yet another alternate application, routing data obtained by individual route table auto-population applications may be centrally collected, edited by a human operator, and distributed to individual modules.

The subject matter described herein is not limited to having route table auto-population application 720 on link interface module 702. Route table auto-population application 720 may implemented on any of the modules in STP 706, including a centralized administrative processing module (not shown in FIG. 3), without departing from the scope of the invention.

Thus, the subject matter described herein includes methods and systems for automatically populating route tables, for example when a node is brought into service. Such route table auto-population reduces the need for network operators to manually provision route tables. This route table auto-population also reduces the time required to bring a node into service. As a result, the deployment of telecommunications network routing nodes, such as STPs, is facilitated.

It will be understood that various details of the invention may be changed without departing from the scope of the invention. Furthermore, the foregoing description is for the purpose of illustration only, and not for the purpose of limitation, as the invention is defined by the claims as set forth hereinafter.

1. A method for automatically populating a route table with route information for a plurality of destination addresses, the method comprising:
(a) storing a plurality of destination addresses in a route table;
(b) activating a first linkset connected to an adjacent node and requesting a list of prohibited destinations;
(c) receiving the list of prohibited destinations; and
(d) for each destination address in the route table that is not in the list of prohibited destinations, sending a message to the adjacent node for determining the status of a route to the destination via the adjacent node, receiving route status information from the adjacent node, and adding routes to the route table based on the received route status information.

2. The method of claim 1 wherein requesting a list of prohibited destinations includes sending a message transfer part (MTP) restart message to the adjacent node.

3. The method of claim 1 wherein sending a message to an adjacent node for determining the status of a route to the destination via the adjacent node includes sending a route set test (RST) message to the adjacent node.

4. The method of claim 3 wherein sending an RST message to the adjacent node includes setting a route status in the RST message to prohibited.

5. The method of claim 4 wherein receiving the route status information form the adjacent node includes receiving a transfer allowed (TFA) message from the adjacent node indicating that a route to the destination address is available via the adjacent node.

6. The method of claim 5 wherein adding routes to the route table based on the received route status information includes adding a route to the route table for a concerned point code in the TFA message, the route associating the concerned point code with a linkset on which the TFA message was received.

7. The method of claim 4 wherein receiving the route status information includes receiving a transfer prohibited (TFP) message from the adjacent node concerning a destination point code and wherein the method further comprises marking a route to the concerned destination as prohibited via the adjacent node.

8. The method of claim 1 comprising repeating steps (b)-(d) for each linkset with each adjacent network element.

9. A method for updating SS7 route status information in a route table for an SS7 signal transfer point (STP) being brought into service, the method comprising:
(a) establishing a secure connection between a first STP and a first adjacent STP;
(b) from the first STP, requesting route tables from the first adjacent STP;
(c) receiving and storing the route tables received from the first adjacent STP; and
(d) repeating steps (a)-(c) for each STP adjacent to the first STP and combining the received route tables into an SS7 route table.

10. The method of claim 9 wherein establishing a secure connection includes establishing a secure connection over an SS7 signaling link.

11. The method of claim 9 wherein establishing a secure connection includes establishing a secure connection over an IP signaling link.

12. The method of claim 9 wherein requesting route tables includes sending a network management message from the first STP to the first adjacent STP.

13. The method of claim 9 wherein combining the received route tables into an SS7 route table includes assigning costs to different routes to the same destination.

14. A method for dynamically populating an SS7 route table, the method comprising:
(a) receiving a signaling message at an SS7 routing node;
(b) determining whether a route to a destination of the SS7 signaling message exists in a route table of the SS7 routing node; and
(c) in response to determining that a route to the destination does not exist in the route table, buffering the signaling message, requesting the route from at least one adjacent node, obtaining the route, and routing the signaling message over the obtained route.

15. The method of claim 14 wherein requesting the route from at least one adjacent node includes requesting the route from a plurality of adjacent nodes, wherein obtaining the route includes receiving routes from the plurality of adjacent nodes, and wherein routing the message over the route includes routing the message over one of the routes received from the adjacent nodes.

16. The method of claim 15 wherein routing the message over one of the routes includes routing the message over a first-received route from the adjacent nodes.

17. The method of claim 15 wherein routing the message over one of the routes includes routing the message over a lowest-cost route received from the adjacent nodes.

18. The method of claim 15 wherein requesting the route from at least one adjacent node includes sending a network management message to the at least one adjacent node.

19. The method of claim 18 wherein the SS7 network management message comprises a route-set-test (RST) message.

20. A network routing element including a self-populating route table, the network routing element comprising:
(a) a link interface module for sending and receiving signaling messages via external signaling links, the link interface module including an SS7 route table, the SS7 route table being usable by the link interface module to route SS7 messages over the external signaling links; and
(b) a route table auto-population application for automatically requesting routing data from at least one adjacent signaling message routing node and for automatically populating the route table with the received routing data.

21. The network routing element of claim 20 wherein the link interface module comprises an SS7 link interface module.

22. The network routing element of claim 20 wherein the link interface module comprises IP link interface module.

23. The network routing element of claim 20 wherein the route table auto-population application is adapted to populate the route table using SS7 network management procedures.

24. The network routing element of claim 20 wherein the route table auto-population application is adapted to populate the route table using a specialized network management message for requesting route tables from an adjacent signaling message routing node that includes a route table auto-population application.

25. The network routing element of claim 24 wherein the adjacent signaling message routing node comprises a signal transfer point.

26. The network routing element of claim 20 wherein the route table auto-population application is adapted to dynamically obtain routing information for a received signaling message in response to receiving a message addressed to a destination for which a route is not present in the SS7 route table.

27. The network routing element of claim 26 wherein the route table auto-population application is adapted to buffer the received signaling message until the route is obtained.

28. The network routing element of claim 27 wherein the route table auto-population application is adapted to dynamically obtain the route using an SS7 network management procedure.

29. The network routing element of claim 28 wherein the network management procedure includes a route-set-test procedure.
